(19) United States
(12) Patent Application Publication
(10) Pub. No.: US 2021/0373276 A1
(43) Pub. Date: Dec. 2, 2021

(54) RETAINER, OPTICAL LENS MODULE HAVING THE RETAINER AND ELECTRONIC DEVICE HAVING THE OPTICAL LENS MODULE

(71) Applicant: HON HAI PRECISION INDUSTRY CO., LTD., New Taipei (TW)

(72) Inventors: LI-SHING HOU, New Taipei (TW); JIAN-JUN JING, Jincheng (CN)

(21) Appl. No.: 17/070,294

(22) Filed: Oct. 14, 2020

(30) Foreign Application Priority Data
Jun. 2, 2020 (CN) 202010491620.5

(51) Int. Cl. G02B 7/02

(52) U.S. Cl. CPC G02B 7/026; G02B 7/022

(57) ABSTRACT

A retainer is a ring around a central axis and includes an upper surface, a lower surface, an outside wall surrounding the central axis, and an inside wall surrounding the central axis. The outside wall is located at a side of the inside wall facing away from the central axis, the inside wall and the outside wall are respectively connected between the upper surface the lower surface. A plurality of grooves is formed on the outside wall and arranged at intervals along a circumferential direction of the outside wall. Each of the plurality of grooves communicates with the upper surface and the lower surface. The disclosure also provides an optical lens module having the retainer, and an electronic device having the optical lens module.

### FIELD

The subject matter herein generally relates to an optical component, and more particularly, to a retainer, an optical lens module having the retainer, and an electronic device having the optical lens module.

### BACKGROUND

Optical lens modules are widely used in electronic devices. When the electronic devices are subjected to external forces such as falling, shaking, knocking, it is easy to cause a displacement of the lenses of the optical lens module.

Therefore, there is room for improvement within the art.

### BRIEF DESCRIPTION OF THE DRAWINGS

Implementations of the present technology will now be described, by way of example only, with reference to the attached figures.

FIG. 1 is a diagram of an embodiment of a retainer.

FIG. 2 is a cross-sectional view of an embodiment of the retainer taken along line II-II of FIG. 1.

FIG. 3 is a cross-sectional view of an embodiment of an optical lens module.

FIG. 4 is a diagram of an embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

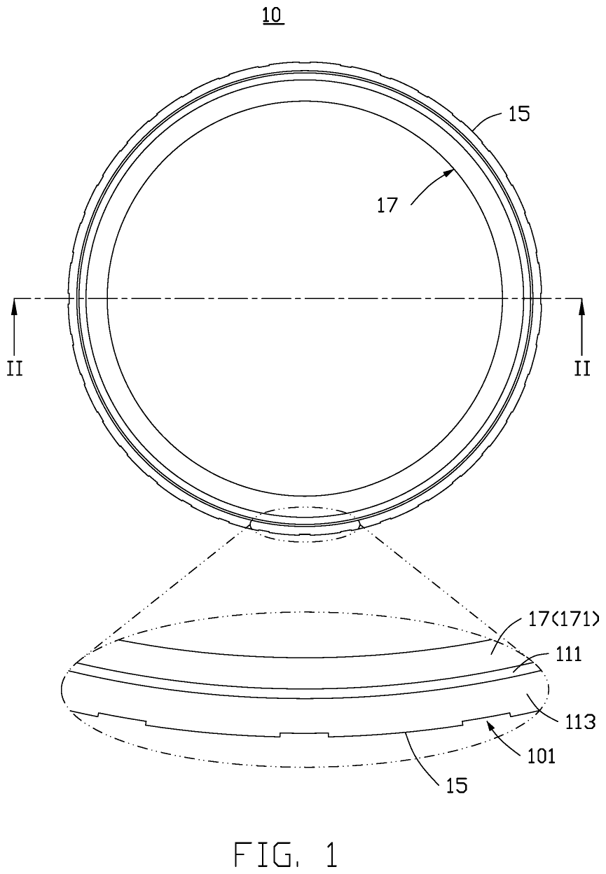

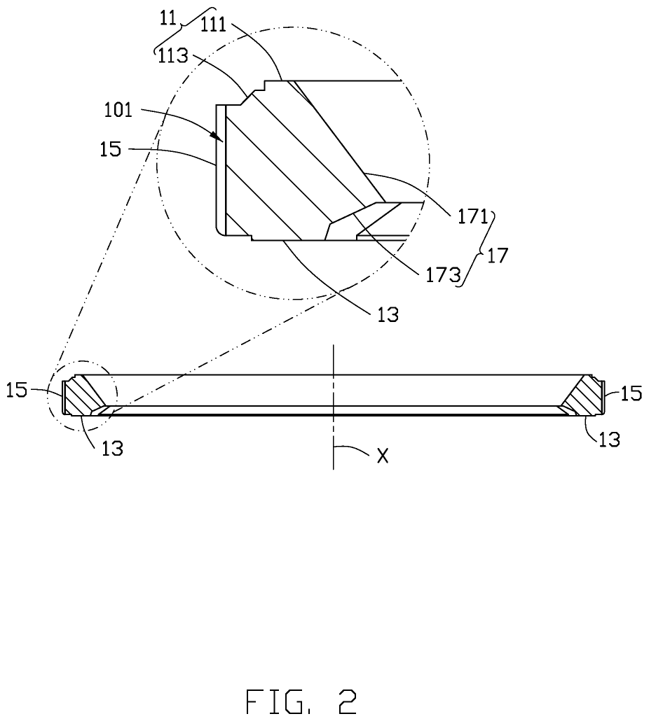

FIG. 1 illustrates an embodiment of a retainer 10. The retainer 10 is a ring around a central axis X (shown in FIG. 2), and includes an upper surface 11, a lower surface 13 (shown in FIG. 2), an outside wall 15, and an inside wall 17. Each of the outside wall 15 and the inside wall 17 has a ring shape and is arranged around the central axis X. The outside wall 15 is located at a side of the inside wall 17 facing away from the central axis X. The outside wall 15 and the inside wall 17 are connected between the upper surface 11 and the lower surface 13, respectively. A plurality of grooves 101 is formed on the outside wall 15 and arranged at intervals along a circumferential direction of the retainer 10. So that an outer edge of the retainer 10 is gear-shaped. Referring to FIG. 2, each groove 101 communicates with the upper surface 11 and the lower surface 13.

In at least one embodiment, the retainer 10 may be a circular ring.

In at least one embodiment, the upper surface 11 may include a first portion 111 and a second portion 113 connecting the first portion 111. The second portion 113 is recessed toward the lower surface 13 compared to the first portion 111. Each groove 101 communicates with the second portion 113 and the lower surface 13.

In at least one embodiment, a width of each groove 101 along the circumferential direction of the retainer 10 is in a range of 0.008 mm to 0.03 mm. A depth of each groove 101 along a radial direction of the retainer 10 is in a range of 1 μm to 5 μm. A distance between two adjacent grooves 101 along the circumferential direction of the retainer 10 is in a range of 0.1 mm to 0.3 mm. So that a diffusion of an adhesive or other substances into the groove 101 is more easily.

In at least one embodiment, each groove 101 corresponds to another groove 101 along the radial direction of the retainer 10. That is, two grooves are arranged in a same radial direction of the retainer 10. In at least one embodiment, sizes of two grooves 101 arranged in the same radial direction of the retainer 10 are the same.

In at least one embodiment, the inside wall 17 may include a first connecting surface 171 and a second connecting surface 173. The first connecting surface 171 extends from an end portion of the upper surface 11 facing away from the outside wall 15 toward a direction close to the central axis X and the lower surface 13. The second connecting surface 173 extends from an end portion of the lower surface 13 facing away from the outside wall 15 toward a direction close to the central axis X and the upper surface 11. An end portion of the first connecting surface 171 away from the upper surface 11 is connected to an end portion of the second connecting surface 173 away from the lower surface 13.

The retainer 10 may be made of a metal material, a plastic material, or a composite of a metal material and a plastic material.

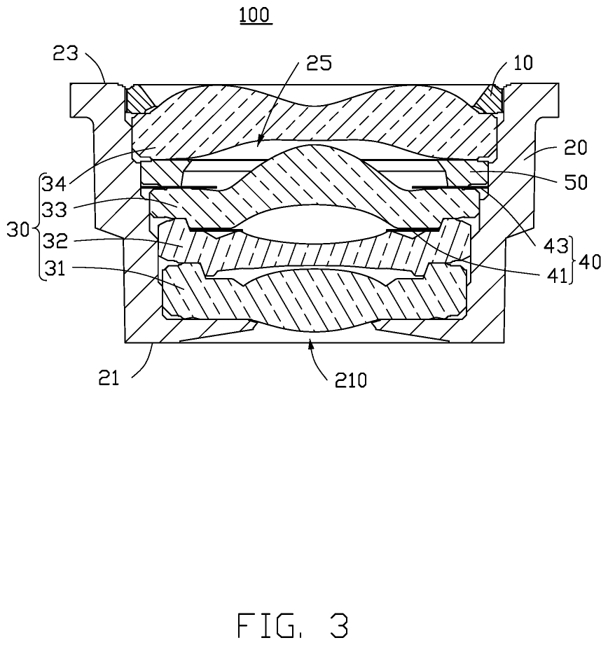

Referring to FIG. 3, the retainer 10 can be applied in an optical lens module 100. The optical lens module 100 includes a lens barrel 20, a lens group 30 and the retainer 10. The lens barrel 20 includes an object side 21, an image side 23, and a receiving space 25 communicating the object side 21 and the image side 23. A through hole 210 is defined on the object side 21 communicates with the receiving space 25.

The lens group 30 and the retainer 10 are received in the receiving space 25. The retainer 10 is arranged on a side of the lens group 30 close to the image side 23. The retainer 10 abuts the lens group 10 and is fixed in the lens barrel 20 by an adhesive (not shown), thereby stabilizing the lens group 30 and improving an imaging quality of the optical lens module 100. Since the plurality of grooves 101 is defined on the retainer 10, the outer edge of the retainer 10 is gear-shaped. The adhesive may easily enter into the grooves 101 to improve a bonding force between the retainer 10 and the lens barrel 20, thereby improving a stability of the lens group 30. When two grooves are arranged in a same radial direction of the retainer 10, an interaction force between the retainer 10 and the lens barrel 20 is more evenly distributed, thereby further improving the stability of the lens group 30.

The lens group 30 may include a plurality of lenses sequentially stacked from the object side 21 toward the image side 23. Each lens includes an optical part (not labelled) and a non-optical part (not labelled) extending from a periphery of the optical part and surrounding the optical part. In at least one embodiment, the lens group 30 includes a first lens 31, a second lens 32, a third lens 33 and a fourth lens 34 stacked in that sequence from the object side 31 toward the image side 23. The retainer 10 is arranged on a side of the fourth lens 34 facing away from the object side 21.

The optical lens module 100 may further include a plurality of filters. Each filter is sandwiched between non-optical parts of two adjacent lenses. In at least one embodiment, the optical lens module 100 further includes a first filter 41 and a second filter 43. The first filter 41 is sandwiched between the second lens 32 and the third lens 33. The second filter 43 is sandwiched between the third lens 33 and the fourth lens 34.

The optical lens module 100 may further include a spacer ring 50. The spacer ring 50 is located between two adjacent optical lens modulees. In at least one embodiment, the spacer ring 50 is located between the third lens 33 and the fourth lens 34.

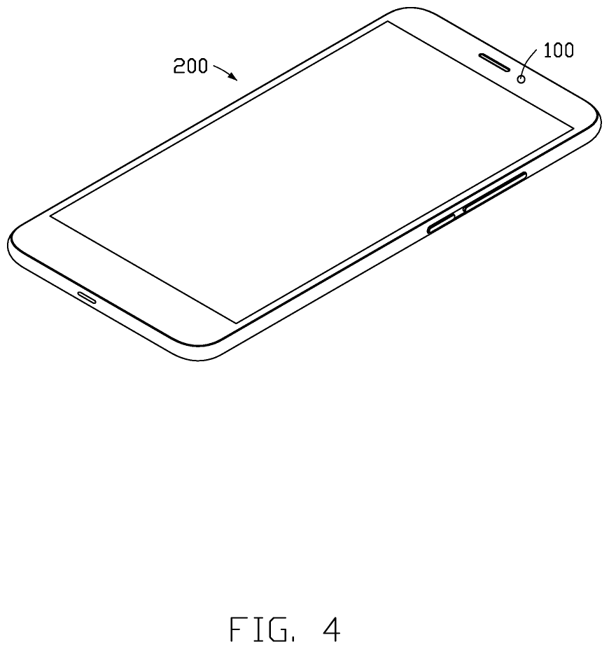

Referring to FIG. 4, the optical lens module 100 can be applied in an electronic device 200, such as a mobile phone, a computer, a surveillance camera, or a toy.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A retainer being a ring around an imaginary central axis, the retainer comprising:
an upper surface;
a lower surface;
an outside wall surrounding the imaginary central axis;
an inside wall surrounding the imaginary central axis;
wherein the outside wall is at a side of the inside wall facing away from the central axis, the inside wall and the outside wall are respectively connected between the upper surface the lower surface, a plurality of grooves is on the outside wall and arranged at intervals along a circumferential direction of the outside wall, each of the plurality of grooves communicates with the upper surface and the lower surface.

2. The retainer of claim 1, wherein a width of each of the plurality of grooves along the circumferential direction of the outside wall is in a range of 0.008 mm to 0.03 mm.

3. The retainer of claim 2, wherein a depth of each of the plurality of grooves along a radial direction of the retainer is in a range of 1 μm to 5 μm.

4. The retainer of claim 2, wherein a distance between two adjacent of the plurality of grooves along the circumferential direction of the outside wall is in a range of 0.1 mm to 0.3 mm.

5. The retainer of claim 1, wherein two of the plurality of grooves are arranged in a same radial direction of the retainer.

6. The retainer of claim 5, wherein sizes of two of the plurality of grooves arranged in the same radial direction of the retainer are the same.

7. The optical lens module of claim 1, wherein the upper surface comprises a first portion and a second portion connecting the first portion, the second portion is recessed toward the lower surface compared to the first portion, each of the plurality of grooves communicates with the second portion and the lower surface.

8. An optical lens module comprising:
a lens barrel defining a receiving space;
a lens group received in the receiving space;
a retainer which is a ring around an imaginary central axis, and is received in the receiving space, the retainer comprising:
an upper surface;
a lower surface;
an outside wall surrounding the imaginary central axis;
an inside wall surrounding the imaginary central axis;
wherein the outside wall is at a side of the inside wall facing away from the imaginary central axis, the inside wall and the outside wall are respectively connected between the upper surface the lower surface, a plurality of grooves is formed on the outside wall and arranged at intervals along a circumferential direction of the outside wall, each of the plurality of grooves communicates with the upper surface and the lower surface, the retainer is fixed in the lens barrel and abuts the lens group thereby stabilizing the lens group.

9. The optical lens module of claim 8, wherein a width of each of the plurality of grooves along the circumferential direction of the outside wall is in a range of 0.008 mm to 0.03 mm.

10. The optical lens module of claim 9, wherein a depth of each of the plurality of grooves along a radial direction of the retainer is in a range of 1 μm to 5 μm.

11. The optical lens module of claim 9, wherein a distance between two adjacent of the plurality of grooves along the circumferential direction of the outside wall is in a range of 0.1 mm to 0.3 mm.

12. The optical lens module of claim 8, wherein two of the plurality of grooves are arranged in a same radial direction of the retainer.

13. The optical lens module of claim 12, wherein sizes of two of the plurality of grooves arranged in the same radial direction of the retainer are the same.

14. The optical lens module of claim 8, wherein the upper surface comprises a first portion and a second portion connecting the first portion, the second portion is recessed toward the lower surface compared to the first portion, each of the plurality of grooves communicates with the second portion and the lower surface.

15. An electronic device comprising:
an optical lens module comprising:
a lens barrel defining a receiving space;
a lens group received in the receiving space;
a retainer which is a ring around an imaginary central axis, and received in the receiving space, the retainer comprising:
an upper surface;
a lower surface;
an outside wall surrounding the imaginary central axis;
an inside wall surrounding the imaginary central axis;
wherein the outside wall is at a side of the inside wall facing away from the central axis, the inside wall and the outside wall are respectively connected between the upper surface the lower surface, a plurality of grooves is formed on the outside wall and arranged at intervals along a circumferential direction of the outside wall, each of the plurality of grooves communicates with the upper surface and the lower surface, the retainer is fixed in the lens barrel and abuts the lens group to stabilizing the lens group.

16. The electronic device of claim 15, wherein a width of each of the plurality of grooves along the circumferential direction of the outside wall is in a range of 0.008 mm to 0.03 mm.

17. The electronic device of claim 16, wherein a depth of each of the plurality of grooves along a radial direction of the retainer is in a range of 1 μm to 5 μm.

18. The electronic device of claim 16, wherein a distance between two adjacent of the plurality of grooves along the circumferential direction of the outside wall is in a range of 0.1 mm to 0.3 mm.

19. The electronic device of claim 15, wherein two of the plurality of grooves are arranged in a same radial direction of the retainer.

20. The electronic device of claim 19, wherein sizes of two of the plurality of grooves arranged in the same radial direction of the retainer are the same.
